(19) United States
(12) Patent Application Publication
(10) Pub. No.: US 2006/0097063 A1
(43) Pub. Date: May 11, 2006

(54) Modular HVAC control system

(76) Inventor: Zvi Zeevi, Houston, TX (US)

Correspondence Address: HAYNES AND BOONE, LLP, 901 MAIN STREET, SUITE 3100, DALLAS, TX, 75202, US

(21) Appl. No.: 11/304,877

(22) Filed: Dec. 15, 2005

(30) Foreign Application Priority Data
Jul. 7, 2000 (WO) PCT/US00/18635

(51) Int. Cl. F24F 7/00; G01K 13/00

(52) U.S. Cl. 236/49.3; 62/129

(57) ABSTRACT

A wireless remote terminal includes a transmitter for sending information to an HVAC electronic controller and to at least one additional wireless remote terminal, a receiver adapted to receiving information from an HVAC electronic controller and to the at least one additional wireless remote terminal, a microprocessor, a temperature sensor, a display, and an input device.

### BACKGROUND OF THE INVENTION

Heating, ventilation, and air conditioning systems (“HVAC”) are used to control the climate on the insides of buildings. A typical system will include equipment for heating, cooling (air conditioning), and filtration to control the temperature, humidity, and air quality of the air in the space where the HVAC system is controlling the climate.

A basic HVAC system includes a thermostat that is wired to an HVAC unit, as well as duct work for distributing the air to the climate controlled locations. The term “HVAC unit” is used to denote what is generally known as an air handler, including equipment for ventilation, air circulation, air cleaning, and heat transfer (either heating or cooling), a humidifier, and/or air filtration or purification equipment. A fan in the HVAC unit is used to pump the conditioned air from the HVAC unit through ducts to the room associated with the HVAC unit. The thermostat senses the temperature of the air in the vicinity of the thermostat and opens or closes a wired, low-voltage control circuit which is used to control the operation of the fan and the heating/cooling equipment, which typically use higher voltage.

The prior art includes so called “wireless” thermostats, which broadcast a control signal to a receiver in an HVAC control unit which in turned is wired to the HVAC unit. The wireless thermostat also may transmit status information, such as a signal indicating that the battery powering the wireless thermostat is near the end of its useful life and needs to be replaced. The thermostat unit itself may have a visual indictor, such as a light or LCD display, for displaying the actual temperature, the desired temperature, and the battery condition. Moreover, the thermostat may be programmable, through an interface such as a keypad and an LCD display located on the thermostat, to automatically change the desired temperature setting depending on time of day, day of the week, etc. Basically, these wireless thermostats function and are used in the same manner as their wired counterparts, but do not use hardwired control lines to communicate with the HVAC control unit.

Typically, the prior art wireless thermostats are intended to replace a conventional wired thermostat. The wireless thermostat is mounted on a wall in a location that may be different from the one in which the original wired thermostat was mounted. In new installations, a wireless thermostat may be used in a location where it is difficult to run control wires from the thermostat to the HVAC unit. In even a standard location, a wireless thermostat may be installed to save the time and cost of running control wires prior to or during installation.

There also are prior art thermostats which are designed to be portable and may be taken from one room in a house to another to change the location at which the air temperature is sensed. It is not unusual in a multi-room structure, such as a house, for the temperature to vary somewhat from floor to floor or room to room due to differences such a room size, variations in the air flow into the room, and other sources of heat or cold in the room (such as windows, doors, and appliances).

A typical wireless thermostat uses a one-way communication link with the HVAC control unit to transmit its status to the HVAC control unit. Typically, the thermostat may transmit a signal indicating the ambient temperature has exceeded (for cooling purposes) or gone below (for heating purposes) the temperature setting or “set point” for the thermostat, which will then activate the HVAC unit. The wireless thermostat also may send a signal to the HVAC control unit to indicate if the system should be in heating or cooling mode.

Typically, only one wireless thermostat is used in connection with a given HVAC unit. Some systems incorporating portable wireless thermostats will permit more than one such thermostat to be used with a given HVAC control unit, but only one of the wireless thermostats can control the HVAC control unit at any given time. Usually the last wireless thermostat for which the desired temperature was adjusted by the user is the active thermostat.

The prior art also includes systems in which a single HVAC unit may be used to provide multi-zone service. These prior art systems use remotely controllable dampers/room registers to control the delivery of conditioned air into each room (or zone). A wireless thermostat may be used in a given room to send control signals to the HVAC control unit based on the temperature sensed by the thermostat and the desired temperature set at the thermostat by the user. The HVAC control unit in turn may broadcast a control signal to the associated damper/register for that room. Communication between the wireless thermostat and the HVAC control unit, as well as communication between the HVAC control unit and the damper/register, is one-way only. The wireless thermostat does not receive information from the HVAC control unit or any of the other thermostats and the damper/register does not send information to the HVAC control unit or the thermostat. The prior art includes systems in which there is a one-way, direct communications link (either hardwired or wireless) between the thermostat and the associated damper/register.

U.S. Pat. No. 5,039,009 discloses a wireless two-way HVAC automation system to link the system's sensing devices, air conditioning device controllers, and system controller. The system controller monitors the operation of as many sensing devices as are in the system and coordinates the activities of as many air conditioning devices as are present in the system.

### SUMMARY OF THE INVENTION

In one aspect, the invention relates to a wireless remote terminal that includes a transmitter for sending information to an HVAC electronic controller and to at least one additional wireless remote terminal, a receiver adapted to receiving information from an HVAC electronic controller and to the at least one additional wireless remote terminal, a microprocessor, a temperature sensor, a display, and an input device.

In another aspect, the invention relates to an HVAC system that includes an HVAC unit, at least two wireless remote terminals, and an electronic control unit operatively coupled to the HVAC unit. The wireless remote terminals are configured to transmit and receive wireless signals to and from the electronic control unit and each other.

In another aspect, the invention relates to an HVAC system that includes an HVAC unit, an electronic control unit operatively coupled to the HVAC unit, and two or more wireless remote terminals in wireless communication with each other and with the electronic control unit. The operating parameters for all of the wireless remote terminals in the system can be inputted through any of the wireless remote terminals, and the status of all of the wireless terminals in the system can be determined using any of the wireless remote terminals.

### BRIEF DESCRIPTION OF THE DRAWINGS

FIG. 1 shows a schematic of one embodiment of an HVAC system.

FIG. 2 shows a schematic of one embodiment of a wireless remote terminal.

FIG. 3 shows a schematic of one embodiment of an electronic controller.

FIG. 4 shows a schematic of one embodiment of an air flow controller.

FIG. 5 shows a schematic of one embodiment of a sensor.

FIG. 6 shows a schematic of one embodiment of an HVAC system.

FIG. 7 shows a schematic of one embodiment of an HVAC system.

FIG. 8 shows a schematic of one embodiment of an HVAC system.

FIG. 9 shows a schematic of one embodiment of an HVAC system.

FIG. 10 shows a schematic of one embodiment of an HVAC system.

### DETAILED DESCRIPTION

The present invention generally relates to a modular control system for controlling a heating, ventilation, and air conditioning (“HVAC”) system. Because the invention is modular, it may be scaled from a relatively simple system to a complex system by combining the various modules, as necessary. Use of the modules enable a single HVAC system to have zones with individually settable temperatures.

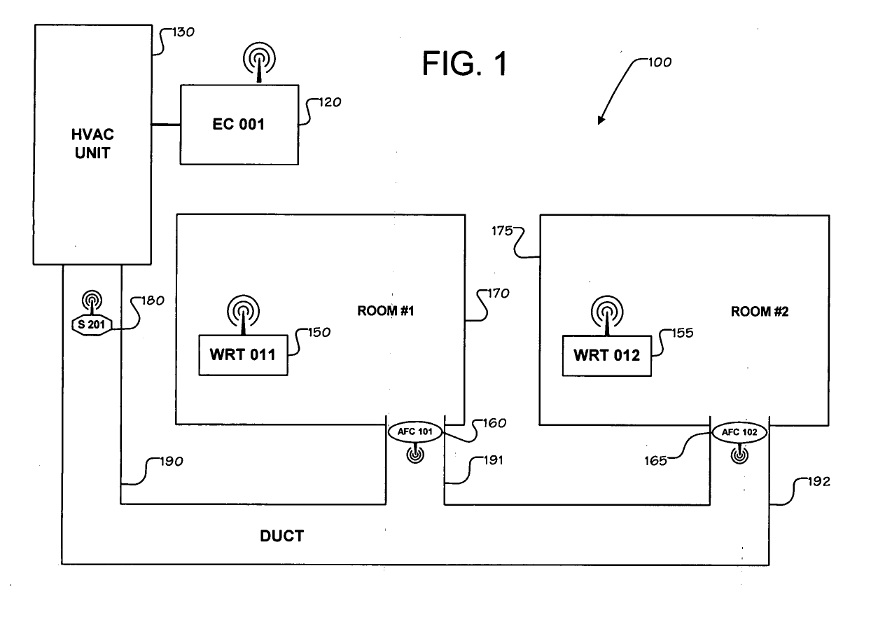

FIG. 1 shows one example of a modular HVAC system 100 in accordance with the invention. An HVAC unit 130 is controlled by an electronic controller (“EC”) 120 to provide conditioned air to rooms #1 and #2 170, 175. The system includes a wireless remote terminal (“WRT”) 150 in room #1 170 and a second WRT 155 in room #2 175. Each of the wireless terminals has its own temperature sensor. The duct work 190, 191, 192 connects the HVAC unit 130 to the rooms 170, 175. The system 100 also includes an additional temperature sensor (“SEN”) 180 positioned in the duct 190 leading out of the HVAC unit 130, and an air flow control devices (“AFC”) 160, 165 associated with each room 170, 175.

In this disclosure, “wireless remote terminal” and “WRT” are used to designate a remote terminal having a temperature sensor that is capable of wireless communication. The term “remote” means that the WRT is not required to be in the same location as an electronic controller or the associated HVAC unit. The WRT may be moveable to any desired location within a certain range, and in that manner it is remote. An “electronic controller” and “EC” are used to designate any device that is capable of receiving wireless signals from a WRT and controlling an HVAC unit, to which the EC is operatively coupled.

A user in room #1 170 may use the WRT 150 to set a desired target temperature for room #1 170. The WRT 150 includes a temperature sensor that enables the WRT 150 to determine whether the temperature in the vicinity of the WRT is above or below the desired temperature set by the user. Similarly, a user in room #2 may use the WRT 155 to set the desired temperature for room #2. The WRT 155 also includes a temperature sensor than enables the WRT 155 to determine whether the temperature in room #2 is above or below the desired temperature.

In one example, the HVAC system 100 may be used to provide air conditioning (i.e., cooled air) to rooms #1 and #2 170, 175. When the temperature in room #1 170 exceeds the desired temperature, the WRT 150 sends a signal to the electronic controller (“EC”) 120 to turn on the HVAC unit 130. When the temperature in room #1 drops below the desired temperature, the WRT 150 may send a signal to the EC 120 to turn off the HVAC unit 130.

Furthering the example, the temperature in room #2 my be below the preselected temperature set for that room. The WRT 155 in room #2 communicates wirelessly with the WRT 150 in room #1, and through that communication, the WRT 155 in room #2 knows that it may not command the EC 120 to turn off the HVAC unit 130. Doing so would stop the flow of cool air through duct 191 into room #2 170. To control the temperature in room #2, the WRT 155 in room #2 175 may send a signal to the AFC 165 associated with room #2 175, instructing the AFC 165 to close, thereby restricting the flow of cool air through duct 192 and into room #2 175.

An additional sensor 180 may be positioned in the duct 190 close to the HVAC unit 130. In this position, the sensor 180 may sense the temperature of the air flowing from the HVAC unit 130 and transmit a wireless signal to the WRTs indicating the relative temperature of the air flowing from the HVAC unit. This may be useful in determining if the HVAC unit 130 is operating properly and providing chilled air or heated air.

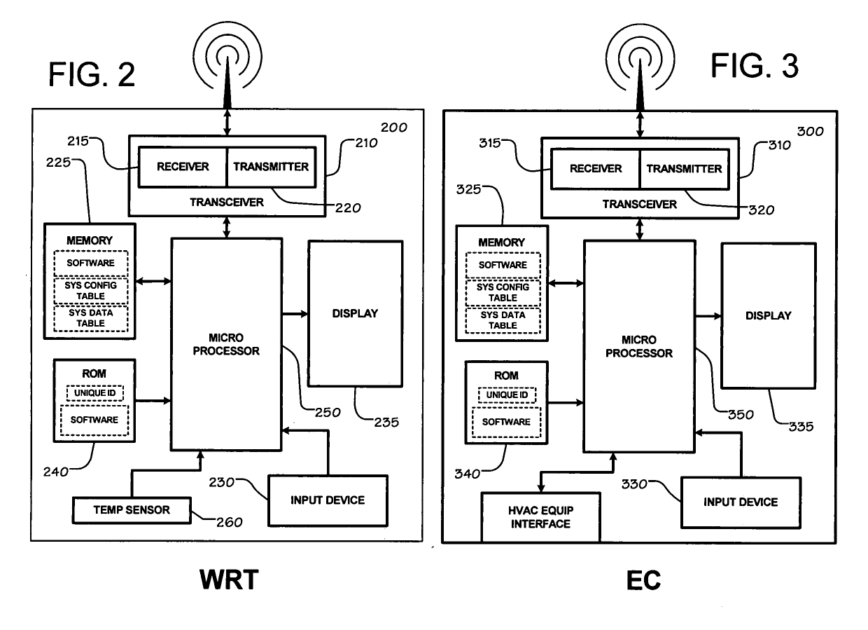

Before describing other embodiments of HVAC systems, the individual components will be described, as shown in FIGS. 2-5.

The WRTs are capable of two way, wireless communication with each other and with the ECs and the AFCs. Optionally, the WRTs may communicate wirelessly with (a) additional accessory modules, such as a remote input device (e.g., a keyboard/keypad, or a touch pad/touch screen) or a remote status display, or (b) a personal computer or PDA for downloading information from, or programming information to, one or more of the WRTs or changing the configuration of the system through any of the WRTs, as described below.

One of the possible embodiments of a WRT 200 is shown in FIG. 2. The WRT 200 includes a radio transceiver 210 for communicating with other devices that are part of the system. The transceiver 210 includes both a receiver 215 and a transmitter 220. Various protocols for wirelessly communicating digital information from one device to another are known in the art, including Bluetooth, ZigBee, GSM, CDMA, IEEE 802.11 (including 802.11a, 802.11b, 802.11g, and 802.11n). Integrated circuits for implementing such receivers are widely available.

The WRT 200 shown in FIG. 2 also includes a memory 225 which stores, in addition to software, system configuration (such as WRT is associated with which ECs/AFCs) and device information (such as temperature set points and time and calendar information for automatically changing temperature set points) for all of the other WRTs on the system and, optionally, the AFCs and ECs. Whenever the system configuration or device information for one of the WRTs is changed by a user, the change may be communicated to all of the other WRTs in the system and stored in one or more tables in the memory of each of the other WRTs.

The WRT 200 in FIG. 2 also includes an (a) input device 230, such as a keypad/keyboard or a touch pad/touch screen which may be used to establish the system configuration and program each of the devices, and (b) a display 235, such as an LCD display, which may display system configuration and system data information. The WRT 200 may be programmed through the use of the input device 230 and the display 235. In addition, because each WRT is in wireless communication, directly or indirectly, to the other WRTs in the system, a single WRT may be used to control and monitor the entire system. Thus, the entire system can be configured, programmed, or monitored using any one of the WRTs.

Moreover, a portable computer or PDA with suitable wireless capability and software can communicate, preferably wirelessly, with a nearby WRT, permitting reprogramming of the temperature set points for any or all of the various WRTs or reconfiguring any part of the system through a single WRT. Similarly, if the WRTs are configured to store historical data about the operation of the system, such as the time in which HVAC units are turned on and off, such historical information may be downloaded into the portable computer or PDA for subsequent analysis as to energy usage, efficiency, etc.

The WRT 200 in FIG. 2 also includes a read only memory 240 which may be used to store software and the unique identification information for the WRT 200. It is understood that either or both of the memories 225 and 240 may be either separate chips or “onboard” the microprocessor 250.

The WRT 200 also includes a temperature sensor 260, which is used to sense the air temperature in the vicinity of the WRT 200. Optionally, the WRT 200 may be configured to be received in a stand or “docking unit,” as described in more detail below.

The ECs are capable of two way, wireless communication with the WRTs. In addition, each EC has an interface which is designed to be hardwired to the HVAC unit being controlled by that EC. Information obtained by EC from a WRT is processed by the EC to determine if any change in the operation of or settings for the associated HVAC equipment is required.

FIG. 3 shows a schematic of one embodiment of an EC 300 in accordance with the invention. The EC 300 includes a radio transceiver 310 for communicating with other devices that are part of the system. The transceiver 310 includes both a receiver 315 and a transmitter 320. The EC may have a ROM 340 (which may be a separate chip or onboard the microprocessor 350) to store software and the unique identification information for the EC 300. The EC 300 shown in FIG. 3 also includes a memory 325 (which may be a separate chip or onboard the microprocessor 350) that may be used to store information about the status of the EC 300 or the associated HVAC equipment and software for processing information received from a WRT and for controlling the HVAC equipment associated with that EC. Optionally, the memory 325 also may store additional information, such as system configuration or program information for one or more of the WRTs or AFCs. Optionally, changes to the configuration or program information for all or any part of the system may be stored in the memory 325 of the EC 300. Optionally, the EC 300 may also include a display 335 for displaying the status of the state of the EC 300, the HVAC equipment it is controlling, and/or another device in the system, permitting all or part of the system to be monitored through the EC 300. Optionally, the EC 300 also may have an input device 330 to input the system configuration and program information for one or more of the devices in the system, permitting all or part of the system to be configured or programmed through the EC 300.

The air flow controllers (“AFC”) (including AFC/SENs) are capable of two-way, wireless communication with the WRTs, including transmitting information about the status of the AFC and/or a sensor associated with an AFC/SEN device. In this disclosure, “air flow controller” and “AFC” are used to designate a device that may be used to control the flow of air. Such a device may be located in or at an exit from a duct for delivering air from an HVAC unit.

An AFC receives commands from a WRT directing the AFC to open or close or, optionally, the level of closure for an AFC capable of variable amounts of airflow restriction. An AFC also may transmit information to a WRT, such as confirmation of receipt of a command from the WRT and the status of the AFC. In addition, an AFC/SEN device is capable of transmitting information from the sensor associated with the AFC/SEN, such as rate of airflow, temperature of air in the duct, etc. to a WRT.

The physical configuration of the AFC may take various forms, including a remotely controlled register at the end of a duct or a remotely controlled damper in the duct. The AFC may be installed in an intermediate location within the duct system such that it is capable of controlling the airflow to more than one location, i.e., the duct may branch downstream of the AFC to deliver conditioned air to more than one location.

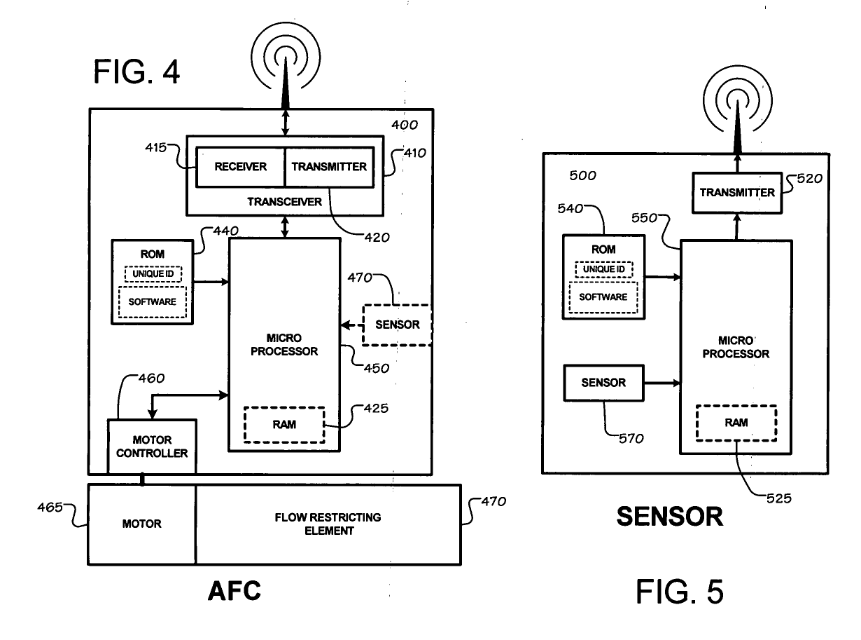

FIG. 4 shows a schematic of one embodiment of an AFC 400 that includes a radio transceiver 410 for communicating with other devices that are part of the system. The transceiver includes both a receiver 415 and a transmitter 420. The AFC 400 also includes a read only memory 440 which stores software for processing the commands received from a WRT (e.g., WRT 150 in FIG. 1) and the unique identification information for the AFC 400. Random access memory 425 may used to store software, the identity of the WRT 400, and information provided by an onboard sensor (if an AFC/SEN device). Either or both of these memories 440 and 425 may be onboard the microprocessor 450 or be a separate IC chip. If the device 400 is an AFC/SEN, it also will have a sensor 470 which provides a signal to the microprocessor 450 indicative of the condition sensed by the sensor 470 (e.g., temperature, airflow).

In addition, the AFC 400 in FIG. 4 has a motor controller 460 and an interface for connection to the electric motor 465 to open and close the damper or other flow restricting element 470 in the AFC 400. The motor 465 may be any motor known in the art, including a stepping motor, for operating a flow restricting element.

A modular HVAC control system may also include sensors at preselected locations. FIG. 5 shows a schematic of a sensor 500 (“SEN”) that includes a transmitter 520 for communicating information provided by a sensor 570. Information is processed by a microprocessor 550 using software in an associated read-only memory 540, which also may contain the unique identification information for the device.

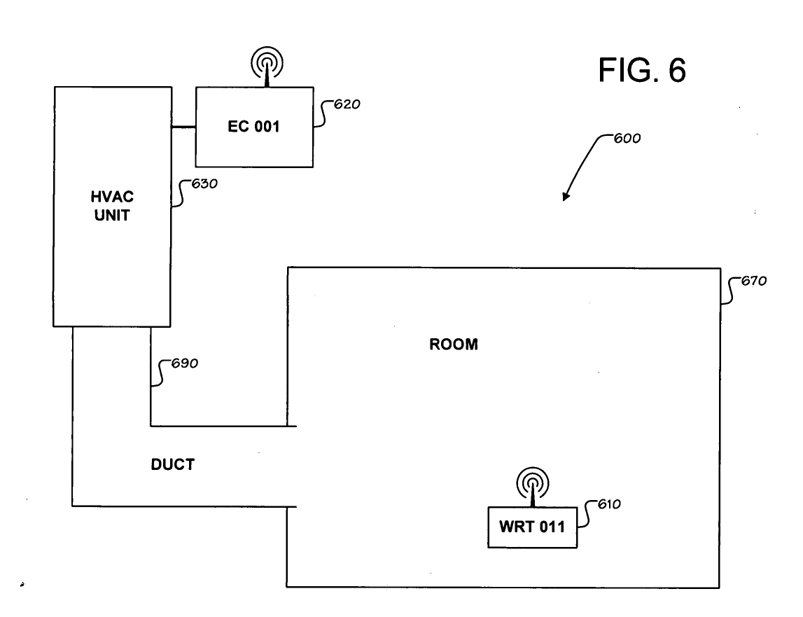

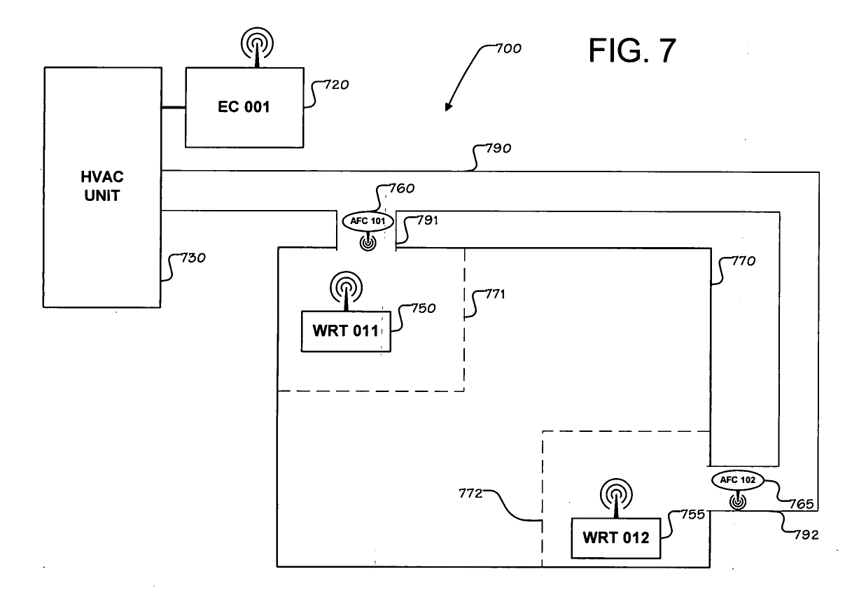

FIG. 6 shows a schematic of one embodiment of a simple HVAC control system 600. The system includes a WRT 610 located in a room 670. The WRT 610 is user programmable so that a user may set the desired temperature of for the room 670. A temperature sensor in the WRT 610 may sense the temperature in the room 670, and the WRT 610 may make decisions about controlling the HVAC system 600. For example, in a cooling application, the WRT 610 may sense that the temperature in the room 670 exceeds the preselected temperature set by a user. In response, the WRT 610 may send a wireless command signal to the EC 620, commanding the EC 620 to turn on the HVAC unit 630 to cool the room 670. The EC may transmit a wireless signal back to the WRT 610 indicating that the command signal was received and the HVAC unit 630 has been turned on.

In an alternative example, the system 600 may be set to heat the room 670 in the winter. In this case, the WRT 620 may sense that the temperature in the room 670 has dropped below the preselected temperature set by a user. In response, the WRT 610 may send a wireless command signal to the EC 620, commanding the EC 620 to turn on the HVAC unit 630 to heat the room 670. The EC 620 may transmit a wireless signal back to the WRT 610 indicating that the command signal was received and the HVAC unit 630 has been turned on.

Referring again to FIG. 1, use of the modules of this system to permit a single HVAC system 100 to have zones with individually settable, differing temperatures. Rooms #1 and #2 170, 175 each have an associated WRT 150, 155, and each WRT 150, 155 is associated with a corresponding AFC device 160, 175. If, for example, the system 100 was in cooling mode, and the temperature in either room 170 or 175 were to exceed the preselected temperature set for that room, the WRT associated with that room would send a signal to the EC 120 commanding it to turn on the HVAC equipment to pump chilled air into the first duct 190. For example, in the temperature in room #1 170 exceeded the preselected temperature, the WRT 150 in room #1 170 would send a signal to the EC 120, commanding it to turn on the HVAC unit 130. The chilled air would flow through the duct 190, which would branch into two separate ducts 191, 192 connected to rooms #1 and #1 150, 155, respectively. Depending on the temperature in room #2, as sensed by WRT 155, the WRT 155 may issue a command to the associated AFC 165 to restrict flow to room #2. In this manner, the flow of chilled air into each of the rooms can be regulated separately, and the target temperature for each of the rooms may be maintained even thought the rooms may be of different sizes, be exposed to additional sources of heat (such as windows), or have different target temperatures. When the temperature in both rooms has reached its target temperature, no further cooling is required, and the WRT 150 in room #1 may send a wireless signal to the EC 130 instructing it to turn off the HVAC unit 130.

As shown in FIG. 1, SEN 180 may be located in the duct 190 to sense the temperature of the air coming from the HVAC unit 130. The information collected by SEN 180 may be wirelessly communicated to the WRTs 150, 155 and the EC 130. In this manner, the WRTs 150, 155 and the EC 130 may determine that the HVAC unit 130 is not functioning properly. For example, if the temperature of the air coming from the HVAC unit 130 is not sufficiently cool, it my be the result of a failure of the HVAC unit 130 to chill the air properly. Similarly, if the temperature of the air coming from the HVAC unit 130 is not sufficiently warm, it may be the result of a failure of the HVAC unit 130 to heat the air properly. Each WRT also may indicate to the user that there is a problem through the WRT unit's display (such as for example a flashing indicator) or an additional onboard alarm.

In addition, because the WRTs 150, 155, the EC 120, and the AFCs 160, 161 are capable of wireless communication, the entire system may be controlled and monitored from a single WRT. For example, a user in room #1 170 may use the WRT 150 to set the set point for the WRT 155 in room #2 175. The WRT 155 in room #2 170 may then transmit wireless signals to the EC 120 and to the AFC 165 associated with room #2 175, based on the temperature sensed by the WRT 155 and the new preselected temperature.

In FIG. 1, the individual zones comprise separate rooms 170, 175. As shown in FIG. 7, the individual zones may comprise different areas 771, 772 in the same room 770. The areas 771, 772 may comprise separate work stations in the same room. The first area 771 includes a WRT 750, and it is located near a duct 791 with an associated AFC 760. The second area 772 includes a WRT 755, and it is located near a duct 792 with an associated AFC 755. Users in each area 771, 772 may use the WRT 750, 755 in the area to set a preselected temperature for that area.

If, for example, the system 700 is in cooling mode, and the temperature in either space 771 or 772 exceeds the temperature set point for the WRT associated with that space, the WRT would send a signal to the EC 120 commanding it to turn on the HVAC unit 730 to pump chilled air into the first duct 790. For example, if the temperature in the first space 771 exceeds the preselected temperature, the WRT 750 in the first area 771 would send a signal to the EC 720, commanding it to turn on the HVAC unit 130. Chilled air would flow through the duct 790, which would branch into two separate ducts 791, 792 connected to the room 770 near the two areas 771, 772. Depending on the temperature in the second space 772, as sensed by WRT 755, the WRT 75 may issue a command to the associated AFC 155 to restrict flow through the second duct 792. In this manner, the flow of chilled air into each of the spaces 771, 772 may be regulated separately, and the target temperature for each of the spaces 771, 772 may be maintained even thought the areas 771, 772 are in the same room 770 and have differing preselected temperatures.

When the temperature in each of the spaces 771, 772 has reached its preselected temperature, no further cooling is required, and the WRT 750 in the first space 771 may send a wireless signal to the EC 720 instructing it to turn off the HVAC unit 730.

Thus, using the system, the temperature in the vicinity of each workstation may be separately regulated. Because the WRTs 750, 755 are portable, each user could be assigned his or her own WRT, and the WRTs may be taken from workstation to workstation, as might be required.

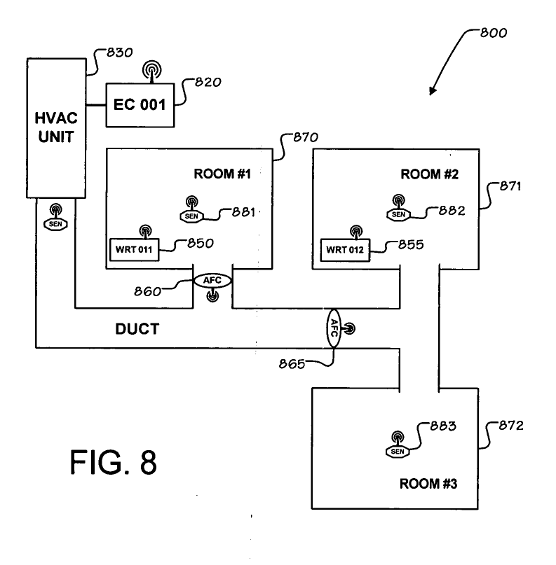

Examples of other system configurations are shown in FIGS. 8-10. In FIG. 8, three rooms 870, 871, 872 are divided into two temperature zones. Room #1 870 comprises the first zone and rooms #2 and #3 871, 872 comprise the second zone. An AFC 760 is positioned in the duct near room #1 870, and it is controlled by WRT 750 to maintain the desired temperature in room #1 870. Another AFC 765 is positioned near rooms #2 and #2 871, 872, and it is controlled by WRT 755 to maintain the desired temperature in rooms #2 and #3 871, 872. In addition, each of rooms #1, #2, and #3 870, 871, 872 may have a motion detector SEN 781, 782, and 783 which can be used to determine whether or not a room is occupied. In the event that no motion is detected for the room within a certain period of time, the room will be considered unoccupied and the target temperature associated with the zone may automatically changed to conserve energy. The WRTs 750, 755 may transmit signals to the EC 720 to control the HVAC unit 730.

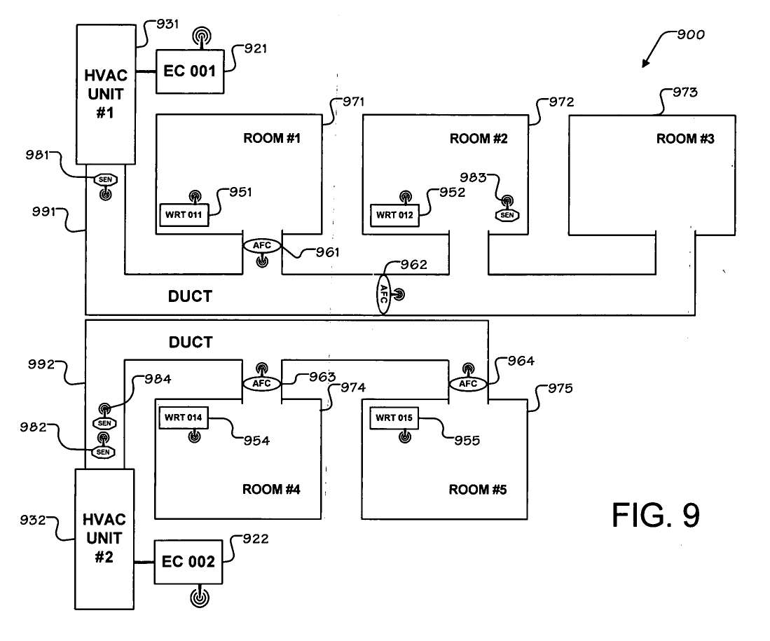

In FIG. 9 shows a system 900 two HVAC units 931, 932, each providing conditioned air to a different group of rooms; HVAC unit #1 931 provides conditioned air through duct 891 to rooms #1-3 971, 972, 973; and HVAC unit #2 932 provides conditioned air to rooms #4 and #5 974, 975. SEN 981 may be located in the duct 991 to sense the temperature of the air coming from HVAC unit #1 931 and SEN 982 may be located in duct 992 to sense the temperature of the air coming from HVAC unit #2 932, thereby providing the system with information regarding the temperature of the conditioned air coming from each of the HVAC units 931 and 932 to permit an analysis of whether each of the units is chilling or heating the air properly. Despite the use of multiple HVAC units 931, 932 in the system, each of the WRTs 951, 952, 954, 955 can communicate with each other, as well as with EC 921 and EC 922, permitting any of the WRTs to be used to monitor the status of and/or program the entire system.

Additional types of sensors also may be available and used as part of the system for other purposes. More specifically, SEN 983 in room #2 972 may be a water sensor that is, for example, mounted in the drip pan for a hot water heater (not shown) located in the room to sense when either the drip pan is about to overflow. In another embodiment, SEN 983 may be a sensor that is attached to a toilet (not shown) to determine if the plumbing associated with the toilet is leaking, or an air conditioning condensate drain pan or drain line. SEN 983 may be used to trigger an alarm condition, which would be communicated to each of the WRTs 951-955, each of which may include or control a visual and/or audible alarm indicator such flashing light or other display element or a siren. Moreover, each of the WRTs 951-955 could be used to determine the location and type of the alarm, as well as deactivate or reset the alarm. Similarly, SEN 984 may be an air quality sensor located in a duct which could monitor for air-borne particulates, such as dust, to signal when the filter(s) for the associated HVAC unit 932 may need to be changed or cleaned.

Moreover, the temperature sensed by the WRT may be programmed to trigger an alarm in the event that the temperature of the room rises to a level indicative of a fire in the room.

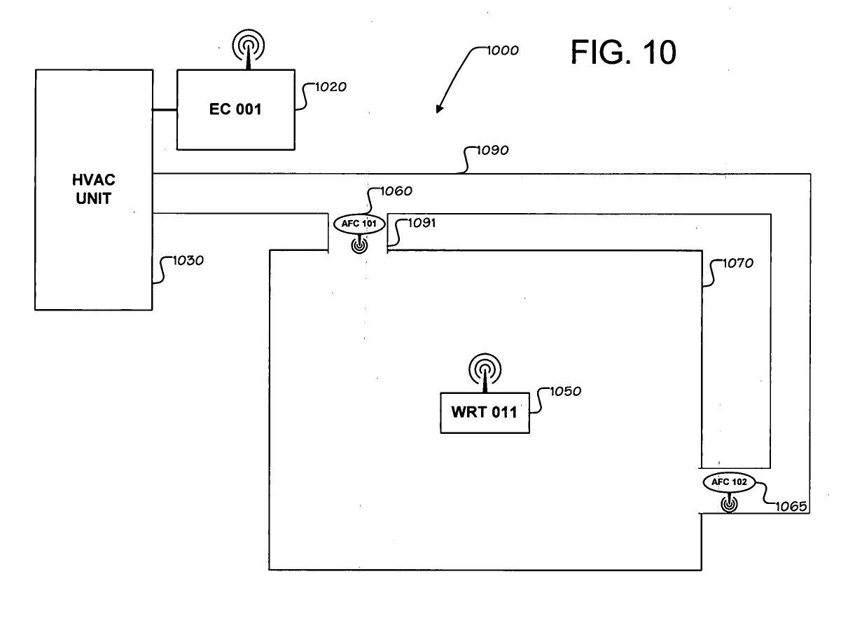

In another system configuration, shown in FIG. 10, a single WRT 1050 may be used to control multiple AFCs 1060, 1065. This could be desirable in a large room 1070, such as an auditorium or ballroom, having multiple registers feeding conditioned air into the room. If the large room 1070 is sometimes divided into smaller rooms, such as is common in many ballrooms, a WRT may be brought into each of the smaller rooms and programmed to control only the AFCs associated with the registers for the smaller room in which it is located. Such embodiments would be similar to the embodiments already described for an HVAC system servicing multiple rooms.

A docking unit (not shown) may be associated with each room or workstation. When the WRT is placed in the docking unit, the docking unit can determine the unique identity of the WRT and provide information to the WRT with respect to its location and the EC and AFC associated with that docking unit. The WRT can then use that information to reconfigure the system automatically without an operator inputting new configuration information into the WRT. Each docking unit can be assigned unique identification information and the system configured to associate that docking unit with a specific AFC. The WRT can automatically determine its location by interrogating the docking unit through external conductors in the WRT which mate with external conductors in the docking unit when the WRT is placed in the docking unit. Based on the system configuration, the WRT will then be able to determine which AFC it is now controlling and direct it commands accordingly. Alternatively, the docking unit may have other ways of communicating its identity, such as a series of indentations in the docking unit, each of which may (or may not) contain a small magnet. When the WRT is placed in the docking unit, magnetic switches in the WRT in locations corresponding to the indentations will sense which indentations contain magnets. In this way, the WRT can determine both (a) whether or not it has been placed in or removed from a docking station, and (b) which docking station it has been placed in, and automatically reprogram the configuration of the system accordingly. In the event that the current system configuration indicates that a docking station does not have a WRT in it, the system may close the AFC associated with that docking station for energy conservation purposes.

In one embodiment, each WRT, AFC, and EC is assigned a unique identification information, such as a serial number, which preferably is preprogrammed into the device in a nonvolatile memory element such as, for example, an EEPROM or user settable DIP switches. Optionally, the identification information may also specify the type of device. A simplified manner of identification of the devices in a system is shown in Table I below by way of example:

TABLE I

| Device Type | Unique Identification No. |
|---|---|
| WRT | 101 |
| WRT | 102 |
| WRT | 103 |
| WRT | 104 |
| AFC | 201 |
| AFC | 202 |
| AFC | 203 |
| AFC | 204 |
| EC | 301 |
| EC | 302 |
| SEN | 401 |
| SEN | 402 |
| AFC/SEN | 501 |
| AFC/SEN | 502 |

The first digit of the unique identification number specifies the type of device (i.e., 1=WRT, 2=AFC, 3=EC, 4=SEN, and 5=AFC/SEN), while the remaining digits uniquely identify each device of that type. For SEN and AFC/SEN devices, another digit may specify the type of sensor associated with the device (e.g., motion detection, temperature, etc.). The unique identification number assigned to each device makes each device in the system addressable and recognizable individually. It is understood that the numbering of the devices need not be sequential, and other identification schemes are usable.

Although illustrative embodiments of the invention have been shown and described, a wide range of modification, changes and substitution is contemplated in the foregoing disclosure. In some instances, some features of the present invention may be employed without a corresponding use of the other features. Accordingly, it is appropriate that the appended claims be construed broadly and in a manner consistent with the scope of the invention.

What is claimed is:

1. A wireless remote terminal, comprising:
a transmitter for sending information to an HVAC electronic controller and to at least one additional wireless remote terminal;
a receiver adapted to receiving information from an HVAC electronic controller and to the at least one additional wireless remote terminal;
a microprocessor;
a temperature sensor;
a display; and
an input device.

2. The wireless remote terminal of claim 1, wherein the wireless remote terminal is configured to program the at least one additional wireless remote terminal by transmitting at least one operating parameter for each of the at least one additional wireless remote terminal.

3. The wireless remote terminal of claim 2, wherein the operating parameter is a temperature set point for the at least one additional wireless remote terminal.

4. The wireless remote terminal of claim 3, wherein the operating parameter is a temperature set point for the wireless remote terminal.

5. The wireless remote terminal of claim 1, further comprising:
a random access memory; and
a read-only memory.

6. The wireless remote terminal of claim 5, wherein the random access memory is configured to store system information and the read only memory is configured to store software and a unique identification for the wireless remote terminal.

7. The wireless remote terminal of claim 6, wherein the system information comprises a temperature set point for the at least one additional wireless remote terminal.

8. The wireless remote terminal of claim 7, wherein the wireless remote terminal is configured to receive signals from a remote sensor indicative of an alarm condition and activate an alarm.

9. An HVAC system, comprising:
an HVAC unit;
at least two wireless remote terminals; and
an electronic control unit operatively coupled to the HVAC unit,
wherein the wireless remote terminals are configured to transmit and receive wireless signals to and from the electronic control unit and each other.

10. The HVAC system of claim 9, further comprising an air flow controller positioned in a duct and configured to communicate wirelessly with the wireless remote terminals.

11. The HVAC system of claim 9, further comprising a wireless sensor unit having a sensor and configured to wirelessly transmit information about a sensed condition to at least on of the remote wireless terminals.

12. The HVAC system of claim 11, where in the wireless sensor is positioned in the duct and configured to measure the temperature of air from the HVAC unit.

13. The HVAC system of claim 11, wherein the wireless sensor comprises a water sensor.

14. The HVAC system of claim 13, wherein the wireless sensor is coupled to one selected from the group consisting of a drip pan and a floor adjacent to a toiler or a washing machine.

15. The HVAC system of claim 9, wherein the wireless remote terminal is a first wireless remote terminal that is associated with a first zone, and further comprising:
a first wireless air flow controller positioned in a first duct and associated with the first zone;
a second wireless remote terminal associated with a second zone; and
a second wireless air flow controller positioned in the duct and associated with the second zone.

16. The HVAC system of claim 15, wherein the first zone comprises a first room, and the second zone comprises a second room.

17. The HVAC system of claim 16, wherein the HVAC unit comprises a first HVAC unit, and further comprising:
a first duct work connecting the first HVAC unit with the first room and the second room,
a second HVAC unit;
a second electronic control unit operatively coupled to the second HVAC unit;
a third wireless remote terminal positioned in a third room and configured to transmit and receive wireless signals to and from the second electronic controller; and
a second duct connecting the second HVAC unit with the third room.

18. The HVAC system of claim 17, wherein the second wireless remote terminal is configured to transmit wireless signals to control the first air flow controller, the second air flow controller, and the electronic controller.

19. An HVAC system, comprising:
an HVAC unit;
an electronic control unit operatively coupled to the HVAC unit; and
two or more wireless remote terminals in wireless communication with each other and with the electronic control unit,
wherein operating parameters for the wireless remote terminals can be inputted through any of the wireless remote terminals.

20. The HVAC system of claim 19, wherein the operating parameters comprise a temperature set point for one or more of the wireless remote terminals.
